(19) United States
(12) Patent Application Publication
(10) Pub. No.: US 2009/0259496 A1
(43) Pub. Date: Oct. 15, 2009

(54) METHOD AND APPARATUS FOR INSURING DIGITAL CONTENT

(75) Inventors: William L. Olson, Palatine, IL (US); Paul Moroney, Olivenhain, CA (US); Petr Peterka, San Diego, CA (US); Theodore S. Rzeszewski, Wheaton, IL (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/101,950

(22) Filed: Apr. 11, 2008

(51) Int. Cl. G06Q 40/00

(52) U.S. Cl. 705/4

(57) ABSTRACT

Embodiments of the invention generally provide a method and apparatus for insuring digital content. One embodiment of a method for insuring digital content includes receiving a request to insure a specific instance of digital content and associating insurance with the instance of digital content, such that the instance of digital content can be restored to an owner of the instance of digital content in an event that the instance of digital content becomes unusable. At least one of: a copy of the at least one instance of digital content, metadata related to the at least one instance of digital content, and data related to the insurance is stored in at least one database.

### FIELD OF THE INVENTION

The present invention generally relates to digital media, and more particularly relates to digital rights management.

### BACKGROUND OF THE INVENTION

Digital Rights Management (DRM) is an umbrella term that refers to technologies used by publishers and/or copyright owners to control access to and usage of digital data (e.g., digital music, images, text, etc.) and digital hardware (e.g., digital media players), and to restrictions associated with specific instances of digital work or devices. For example, DRM may control the number of times that a legitimate owner of a specific instance of a digital work may reproduce that instance of work for his or her own use, to control the manner in which the owner may share the instance of work with others, or to control the manner in which the owner may transfer ownership of the instance of work to another party.

Currently, however, there is little or no protection offered to owners whose legitimately purchased instances of digital content become corrupted, lost, or destroyed (e.g., due to hardware malfunction or other damage), or whose legitimately purchased instances of digital content are saved in formats that are no longer supported by current generation devices. It can therefore become quite costly to replace legitimately purchased instances of digital content that become damaged and/or to ensure that such instances of digital content do not become obsolete due to advances in technology.

Therefore, there is a need in the art for a method and apparatus for insuring digital content.

### SUMMARY OF THE INVENTION

Embodiments of the invention generally provide a method and apparatus for insuring digital content. One embodiment of a method for insuring digital content includes receiving a request to insure a specific instance of digital content and associating insurance with the instance of digital content, such that the instance of digital content can be restored to an owner of the instance of digital content in an event that the instance of digital content becomes unusable. At least one of: a copy of the at least one instance of digital content, metadata related to the at least one instance of digital content, and data related to the insurance is stored in at least one database.

In another embodiment, a computer readable medium contains an executable program for insuring digital content, where the program performs the steps of: receiving a request to insure a specific instance of digital content and associating insurance with the instance of digital content, such that the instance of digital content can be restored to an owner of the instance of digital content in an event that the instance of digital content becomes unusable. At least one of: a copy of the at least one instance of digital content, metadata related to the at least one instance of digital content, and data related to the insurance is stored in at least one database.

In another embodiment, a method for insuring digital content includes receiving a request to insure a specific instance of digital content and associating insurance with the instance of digital content, such that the instance of digital content can be restored to an owner of the instance of digital content in an event that the instance of digital content becomes unusable. A price at which the instance of digital content is insured is discounted if the owner of the instance of digital content insures a minimum number of instances of digital content.

In another embodiment, a method for insuring digital content includes receiving a request to insure a specific instance of digital content and associating insurance with the instance of digital content, such that the instance of digital content can be restored to an owner of the instance of digital content in an event that the instance of digital content becomes unusable. A price at which the instance of digital content is insured is at least partially dependent on a file quality of the at least one instance of digital content.

In further embodiments, insurance may be used to protect personal content or to provide a discount to purchase a better-quality version of the insured content. In the former case, the insurance can be used to convert content from obsolete formats to new formats supported by the owner's new devices.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram illustrating one embodiment of a system for insuring digital content, according to the present invention;

FIG. 2 is a flow diagram illustrating one embodiment of a method for insuring digital content, according to the present invention;

FIG. 3 is a flow diagram illustrating one embodiment of a method for restoring an insured instance of digital content, according to the present invention; and

FIG. 4 is a high level block diagram of the present digital content insurance method that is implemented using a general purpose computing device.

To facilitate understanding, identical reference numerals have been used, where possible, to designate identical elements that are common to the figures.

### DETAILED DESCRIPTION

Embodiments of the invention generally provide a method and apparatus for insuring digital content. In one embodiment, the invention creates a “purchase once” model that allows an owner of an instance of digital content to insure the instance of digital content against future loss (e.g., due to hardware malfunction or other damage) and/or changes in technology that threaten to make the instance of digital content obsolete. The rights to the instance of digital content are thus independent of the digital format or the storage medium in/on which the instance of digital content was originally purchased.

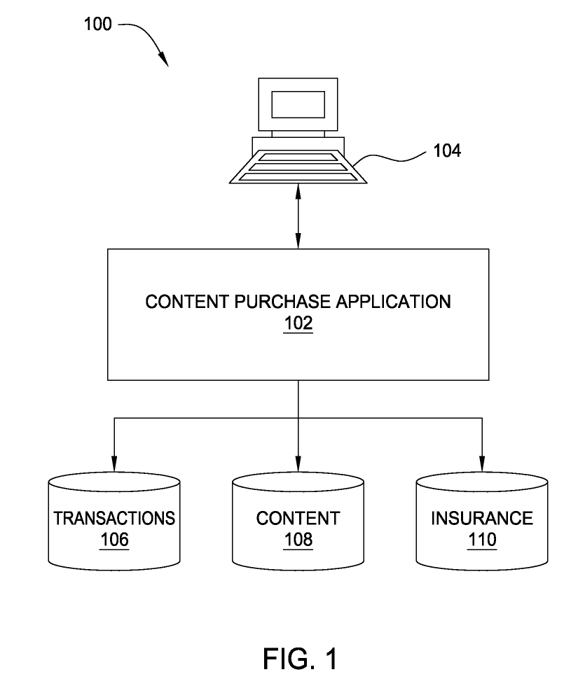

FIG. 1 is a schematic diagram illustrating one embodiment of a system 100 for insuring digital content, according to the present invention. The system may be implemented, for example, in the context of a DRM system.

The system 100 includes a content purchase application 102 that is accessible to a user (i.e., a content purchaser) via a user interface 104. In one embodiment, the user interface 104 comprises any user computing device that allows a user to access the content purchase application 102, such as a desk top computer, a lap top computer, a cellular telephone, a personal digital assistant, a gaming console, a set top box, a digital video recorder, a digital media player, or the like.

The content purchase application 102 allows the user to purchase (e.g., by download to the user interface 104) an instance of digital content, such as a digital music file, a digital video file, a digital image file, or the like. In one embodiment, the content purchase application 102 is web-based (i.e., accessed via a network). In another embodiment, the content purchase application 102 is application-based (i.e., installed on a user device).

The content purchase application 102 is coupled to a plurality of databases. In one embodiment, these databases include a content database 108, a transactions database 106, and an insurance database 110. The content database 108 stores copies of the content (e.g., digital music files, digital text files, digital image or video files, software applications, etc.) that is available for purchase via the content purchase application 102. Content stored in the insurance database 110 may be stored in a raw format to allow for the highest quality of future compression formats and/or to avoid transcoding from old to new formats. The insurance database 110 may be implemented as multiple databases, where, for example, a first database stores the insured content, a second database stores metadata related to the insured content, and a third database stores information about insurance policies and other attributes related to the insurance. In further embodiments, the insurance database 110 stores associations between users and their purchased insurance policies, as well as identifications of content purchased by the user that are covered by the insurance policies.

The transaction server 106 stores records of all purchase transactions (i.e., in which a user has purchased content via the content purchase application). The insurance database 110 stores files that have aged out (i.e., are no longer available for purchase, for example due to obsolete format), but that include the bit indicating that the files were offered for purchase.

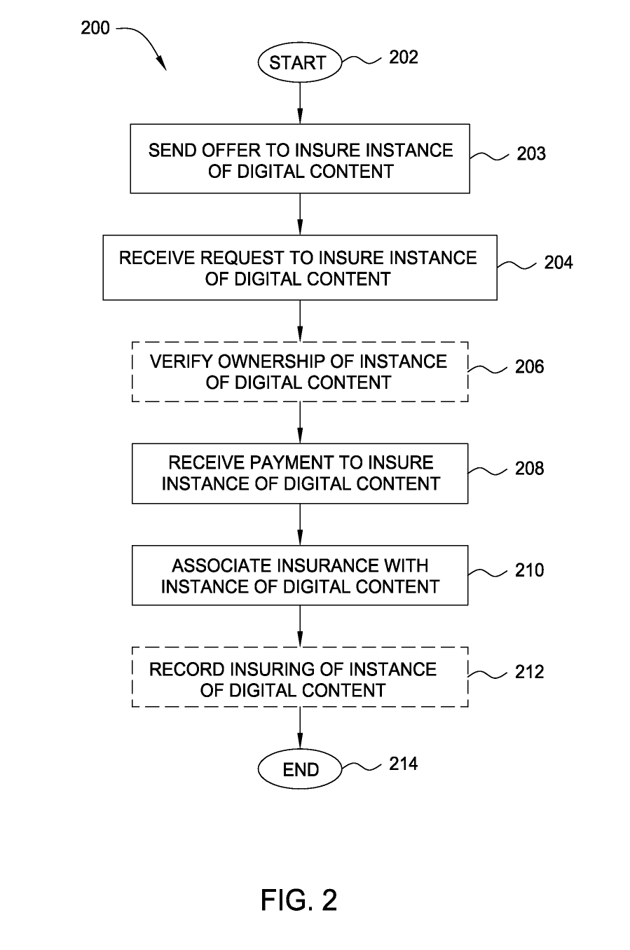

FIG. 2 is a flow diagram illustrating one embodiment of a method 200 for insuring digital content, according to the present invention. The method 200 may be implemented, for example, by a service that provides digital content (e.g., the system 100 illustrated in FIG. 1) or by a service that provides digital content insurance.

The method 200 is initialized at step 202 and proceeds to step 203, where the method 200 sends an offer to an owner of an instance of digital content to insure at least one instance of digital content. In one embodiment, the offered insurance insures the instance of digital content against at least one of: loss (e.g., file corruption) and lack of technological support (i.e., obsolescence due to technological advancement). In one embodiment, the offer includes the option to insure the instance of digital content for a predefined period of time (e.g., 1 year, 3 years, or 5 years). In one embodiment, the provider of the instance of digital content automatically insures the instance of digital content for a predefined period of time after purchase (e.g., one year). This is an equivalent of a warrantee. According to this embodiment, upon the expiration of the predefined period of time, the method 200 automatically sends the offer in step 203 in order to extend the insurance period.

In one embodiment, where the offer offers to insure multiple instances of digital content, or where the owner of the instance of digital content to be insured has previously purchased and insured other digital content from the same digital content provider, the offer may offer a reduced or bundled insurance rate. For example, a digital content provider, such as an online site that sells mp3 music files or a particular music label, may offer a reduced per-file insurance rate (e.g., $0.10 per file for less than X files, or $0.8 per file for X or more files) or a flat bundled insurance rate (e.g., $1.00 for X files) if a user purchases a minimum number of files from the digital content provider. Alternatively, the digital content provider may offer free insurance if the user purchases a minimum number of instances of digital content. In another embodiment, where the insurance is provided through a third-party provider (i.e., not the digital content provider), the third-party provider may offer discounts if an owner of digital content insures a minimum number of instances of digital content. In a further embodiment still, the price of insurance according to the offer is at least partially based on the file quality of the instance of digital content to be insured (e.g., a video filed formatted for display on a cellular telephone may cost less to insure than a high definition video file) or on additional options available to the owner of the instance of digital content (e.g., an option to be able to upgrade the format quality of the instance of digital content may cost extra). In yet another embodiment, the insurance may be a renewable policy with annual payments covering all content purchased by a user and covered by the user's insurance policy.

A DRM system may maintain a lost of content IDs for content purchased by a user and the associated rights, as well as an indication as to what insurance policy the content is covered by. Information about purchased insurance may also be securely stored in a license maintained by the DRM system on the user's device.

In step 204, the method 200 receives a request from the digital content owner to insure the instance(s) of digital content. For instance, the digital content owner may wish to insure a particular mp3 music file, or a plurality of cellular telephone ring tones.

In optional step 206 (illustrated in phantom), the method 200 verifies ownership of the instance of digital content to be insured. That is, the method 200 verifies that the person requesting insurance is the legitimate owner of the instance of digital content to be insured. In one embodiment, verification involves requesting a first digital receipt from the owner of the instance of digital content, where the first digital receipt was provided upon purchase of the instance of digital content and proves ownership. In some cases, the first digital receipt (proving ownership) also allows the instance of digital content to be played on a user device. In another embodiment, verification involves checking a database of transactions (e.g., transactions database 106 of FIG. 1) for a record of the purchase. In another embodiment still, verification involves checking some form of owner identification (e.g., a credit card or passport number). In another embodiment, the instance of digital content is not purchased, but is the digital content owner's personal content (e.g., a family video or vacation photos). In this case, the digital content owner may not have to provide proof of ownership. Also in this case, the content may not be in the insurance database (e.g., insurance database 110) of the insurance provider. Instead, the content may be uploaded by the owner at the time that a format conversion is requested. This type of personal content insurance may be offered by manufacturers of consumer electronics equipment (e.g., manufacturers of video cameras, DVD burners, still cameras, audio recorders, or the like).

In step 208, the method 200 receives payment to insure the instance of digital content. Alternatively, the content insurance may be prepaid and may cover a certain amount of content obtained before and/or after the insurance policy was established.

In step 210, the method 200 associates insurance with the instance of digital content. In one embodiment, association of insurance with an instance of digital content involves issuing a second digital receipt proving purchase of the insurance. In the case where the request for insurance is received at the time of the purchase of the instance of digital content, a single digital receipt may be issued in step 210, proving both ownership and purchase of insurance.

In optional step 212 (illustrated in phantom), the method 200 records insuring the instance of digital content. For example, the method 200 may store copies of the first digital receipt and/or the second digital receipt (e.g., locally or on a remote database). In some embodiments, the owner of the instance of digital content is solely responsible for maintaining the first digital receipt and the second digital receipt, and the method 200 will not store copies.

The method 200 then terminates in step 214.

The method 200 thereby substantially ensures that an instance of digital content is protected and preserved in the event that the instance of digital content becomes unusable (e.g., due to file corruption, hardware malfunction, technology upgrade, or the like). The method 200 provides financial and media resources to recover and restore existing instances of digital content. Moreover, in the event that an instance of digital content exists in a file format that is no longer supported by current generation technology, the method 200 covers the costs of converting the instance of digital content to a supported format. In accordance with the method 200, an owner of an instance of digital content may insure the instance of digital content at the time of purchase or after. Different policies may exist; for instance, content loss and/or damage policies are different from content format upgrade policies and content quality upgrade policies. Not all content owned by the user must necessarily be covered by the same insurance policy. Even if the content format is still supported, a DRM system protecting the content may be obsolete or breached. For instance, a DRM system on a device may have been revoked, in which case digital content will need to be protected by another valid DRM system present on the device (or present on another device owned by the same user). Another type of policy may cover downgrading the quality of the digital content for transfer to handheld or portable devices (e.g., assuming that the device containing the digital content cannot transcode the digital content for the portable device, or the DRM system cannot protect the transcoded version).

Moreover, the use of digital receipts to verify ownership and insurance makes it easier for content to be transferred. For example, in some embodiments, insurance purchased for an instance of digital content may be transferable with the instance of digital content. Thus, for example, if the original owner of an insured mp3 music file transferred the mp3 music file to a new owner (for instance, as a gift or through a sale), the new owner would receive the insurance (e.g., including the second digital receipt) as well as the mp3 music file (e.g., including the first digital receipt). Thus, the new owner would be able to replace the mp3 music file in the event that the mp3 music file became corrupted or technologically obsolete. In such a case, all copies of the instance of the digital content residing on devices belonging to the original owner, as well as any receipts or copies thereof proving ownership and/or insurance are removed from the devices belonging to the original owner. In one embodiment, removal of copies is performed in accordance with the methods described in U.S. patent application Ser. No. 11/739,868, filed Apr. 25, 2007 [Attorney Docket No. BCSO4354], which is herein incorporated by reference in its entirety.

In a further embodiment, the use of digital receipts (and the retention of the digital receipts by the owner and by the insurance provider/clearinghouse) allows for transfer of insurance between insurance providers. For instance, if an owner of digital content wanted to start using a new insurance provider to insure his or her digital content, he or she could transfer any digital content already insured by an old insurance provider under a common umbrella.

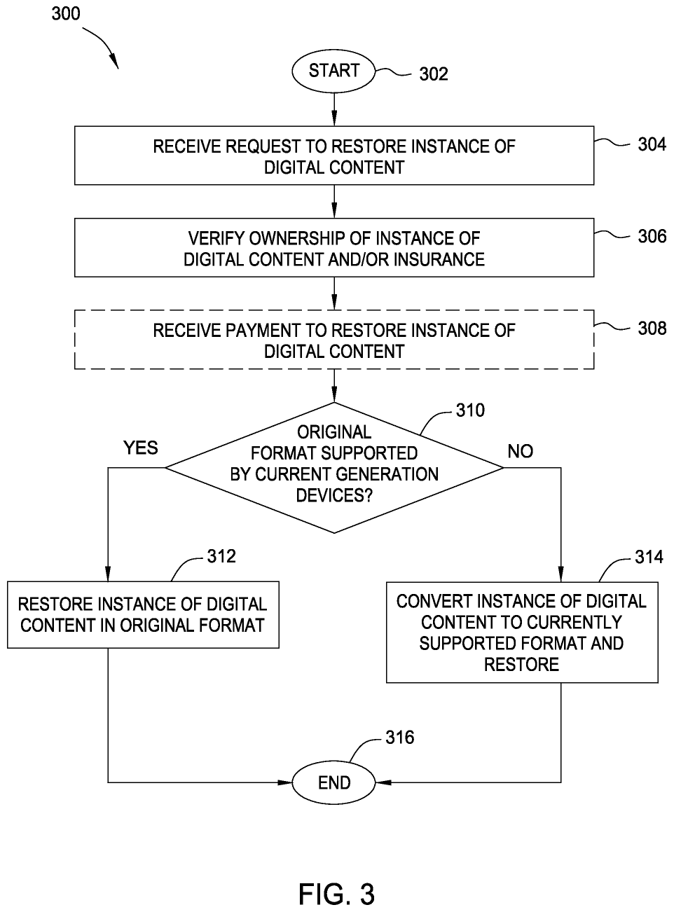

FIG. 3 is a flow diagram illustrating one embodiment of a method 300 for restoring an insured instance of digital content, according to the present invention. Like the method 200, the method 300 may be implemented, for example, by a service that provides digital content (e.g., the system 100 illustrated in FIG. 1) or a service that provides digital content insurance.

The method 300 is initialized at step 302 and proceeds to step 304, where the method 300 receives a request from a digital content owner to restore an insured instance of digital content. For example, the owner may wish to replace an insured mp3 file that was corrupted (e.g., due to hardware malfunction). The request may include information such as user identification, content identification, insurance policy number, device information, DRM information, or the like.

In step 306, the method 300 verifies ownership of the instance of digital content and/or the existence of insurance for the instance of digital content. That is, the method 300 verifies: (1) that the person requesting replacement of the instance of digital content is the legitimate owner of the instance of digital content; and/or (2) that the instance of digital content is insured. In one embodiment, either or both of these facts is verified by the provision of a digital receipt. The digital receipt may be provided by the owner of the instance of digital content or may be retrieved from a universal database that serves as a repository of past digital content purchase transactions. In another embodiment, these facts are verified by checking a database of transactions (e.g., transactions database 106 of FIG. 1) for a record of the purchase of the instance of digital content. In case the content is allowed to be resold or transferred, subsequent transactions indicating the change of ownership of the instance of digital content must be checked. In another embodiment still, verification involves checking some form of owner identification (e.g., a credit card or passport number). The validity of the insurance policy must also be verified (e.g., the policy could have been terminated, lapsed for nonpayment, etc.).

In optional step 308 (illustrated in phantom), the method 300 receives payment to restore the instance of digital content. Whether or not payment is required in accordance with step 308 depends on the policy insuring the instance of digital content. In one embodiment, the owner of an instance of digital content is required to pay a fee each time the instance of digital content is restored. In another embodiment, the owner of an instance of digital content pays a one-time or recurring (e.g., yearly) fee to insure the instance of digital content, which allows for a limited or unlimited number of restorations. Quality upgrades may require an extra payment.

In step 310, the method 300 determines whether the original format of the insured instance of digital content is supported by current generation devices. For example, in the example described above, the method 300 might determine whether current generation devices are capable of playing mp3 files.

If the method 300 concludes in step 310 that current generation devices will support the insured instance of digital content in its original format, the method 300 proceeds to step 312 and restores the instance of digital content in its original form before terminating in step 316.

Alternatively, if the method 300 concludes in step 310 that current generation devices will not support the insured instance of digital content in its original format, the method 300 proceeds to step 314 and converts the instance of digital content to a currently supported format before providing the (converted) instance of digital content to the digital content owner and terminating in step 316.

In one embodiment, an instance of digital content can only be restored in accordance with the method 300 in a format or resolution that is equivalent to the originally purchased format or resolution. In a further embodiment of the method 300, the owner of an insured instance of digital content is provided with the option to pay an additional fee to receive an upgraded version of the instance of digital content. For instance, if the original instance of digital content was a standard definition digital video file, the method 300 could restore the instance of digital content to the owner as a high definition digital video file for an additional fee.

Embodiments of the present invention can be further applied to cover the costs of recovering files on devices (e.g., hard drives) that have crashed. In such a case, the present invention would cover the expense of recovering digital data from the failed device and storing the recovered digital data on a new device of the owner's choosing. This embodiment assumes that the content cannot be recovered from an insurance database (e.g., insurance database 110), or that the digital receipts were kept on the damaged device instead of on a transaction or insurance database (e.g., transaction database 106 or insurance database 110).

The restored, recovered, converted, or upgraded digital content may be protected by a DRM system, which may be the same or different from the DRM system used to protected the original digital content. Even if the same DRM system is used, a new license (or equivalent) may need to be delivered to a replacement device (e.g., in case the original device was damaged).

As discussed above, the present invention may be extended to insure not only purchased instances of digital content, but also to insure personal digital content such as family videos or vacation photos located on personal media equipment. As in the case of purchased content, personal content may be insured to cover the costs associated with recovery of digital content that has been inadvertently corrupted or destroyed (e.g., through hardware or software failure), or that exists in an obsolete format. In one embodiment, personal content can be restored in any format desired. For individuals who store a great deal of personal content on personal media equipment such as laptop computers or personal digital assistants, this insurance model may provide a more cost-effective alternative to conventional recovery or backup services. In one embodiment, insurance for personal content is associated with an actual device (e.g., a personal media device) and extends to at least a portion of the digital content stored thereon. In one embodiment, a user of an associated service to restore personal digital content is only required to pay when personal content is actually restored. In one embodiment, the provider of the service also maintains any servers required to provide the service.

In a further embodiment, personal content is further insured against file tampering and/or destruction by third parties. For example, the insurance might insure personal content that has been posted on an Internet web site (e.g., a file sharing or viral video site) against misuse or misappropriation (theft, destruction, modification, distribution, etc.) by users of the site. In this case, the insurance might, for example, cover the costs to restore the digital content to its original form and/or to enforce copyright against third parties. In one embodiment, assistance in enforcing the copyright is provided in exchange for some portion of any damages awarded to the owner of the personal content.

In one embodiment, upon receipt of a request to insure personal content, a service providing the insurance validates the original content and certifies personal ownership. When the insurance is later invoked, the insurance provider analyzes the file(s) associated with the third party (i.e., files suspected of being copied or modified from the insured personal content) in order to verify the source.

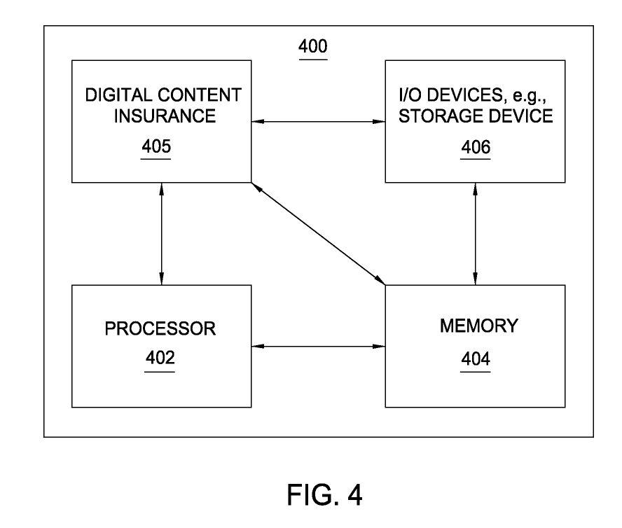

FIG. 4 is a high level block diagram of the present digital content insurance method that is implemented using a general purpose computing device 400. In one embodiment, a general purpose computing device 400 comprises a processor 402, a memory 404, an insurance module 405 and various input/output (I/O) devices 406 such as a display, a keyboard, a mouse, a modem, a network connection and the like. In one embodiment, at least one I/O device is a storage device (e.g., a disk drive, an optical disk drive, a floppy disk drive). It should be understood that the insurance module 405 can be implemented as a physical device or subsystem that is coupled to a processor through a communication channel.

Alternatively, the insurance module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Additionally, the software may run in a distributed or partitioned fashion on two or more computing devices similar to the general purpose computing device 400. Thus, in one embodiment, the insurance module 405 for insuring instances of digital content described herein with reference to the preceding figures can be stored on a computer readable medium or carrier (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

Thus, the present invention represents a significant advancement in the field of digital media. Embodiments of the invention generally provide a method and apparatus for insuring instances of digital content in the event of file corruption, hardware malfunction, technology upgrade, or the like. Embodiments of the present invention provide financial and media resources to recover and restore existing instances of digital content. Moreover, in the event that an instance of digital content exists in a file format that is no longer supported by current generation technology, the present invention covers the costs of converting the instance of digital content to a supported format. Thus, an owner of an insured instance of digital content avoids liability for changes in technology which might render the instance of digital content unusable.

While the foregoing is directed to embodiments of the invention, other and further embodiments of the invention may be devised without departing from the basic scope thereof.

What is claimed is:

1. A method for insuring digital content, the method comprising:
receiving a request to insure at least one instance of digital content;
associating insurance with the at least one instance of digital content, such that the at least one instance of digital content can be restored to an owner of the at least one instance of digital content in an event that the at least one instance of digital content becomes unusable; and
storing, in at least one database, at least one of: a copy of the at least one instance of digital content, metadata related to the at least one instance of digital content, and data related to the insurance.

2. The method of claim 1, wherein the insurance provides for at least one of: replacement of the at least one instance of digital content due to loss, replacement of the at least one instance of digital content due to file corruption, upgrade of a format of the at least one instance of digital content, upgrade of a quality of the at least one instance of digital content, replacement of the at least one instance of digital content due to obsolescence of a digital rights management system protecting the at least one instance of digital content, or replacement of the at least one instance of digital content due to revocation of a device on which the at least one instance of digital content resides.

3. The method of claim 1, further comprising:
verifying ownership of the at least one instance of digital content prior to associating the insurance.

4. The method of claim 3, wherein the verifying comprises:
checking a database of transactions for a record of purchase of the at least one instance of digital content and for a record of any subsequent transfer for the at least one instance of digital content to a new owner.

5. The method of claim 1, wherein the associating comprises:
issuing a digital receipt proving that the at least one instance of digital content is insured.

6. The method of claim 5, further comprising:
storing the digital receipt by at least one of: a provider of the at least one instance of digital content, an insurer of the at lest one instance of digital content, or the owner of the at least one instance of digital content.

7. The method of claim 5, further comprising:
providing the digital receipt to the owner of the at least one instance of digital content.

8. The method of claim 5, further comprising:
transferring the digital receipt from a first insurance provider to a second insurance provider.

9. The method of claim 5, wherein the digital receipt is maintained by a digital rights management system that protects the at least one instance of digital content.

10. The method of claim 1, wherein a price at which the at least one instance of digital content is insured is at least partially dependent on a file quality of the at least one instance of digital content.

11. The method of claim 1, wherein the receiving and the associating occur at a time after the at least one instance of digital content is purchased.

12. The method of claim 1, further comprising:
discounting a price at which the at least one instance of digital content is insured if the owner of the at least one instance of digital content insures a minimum number of instances of digital content.

13. The method of claim 1, further comprising:
automatically sending an offer to insure the at least one instance of digital content upon the expiration of a predefined period of time, before the receiving.

14. The method of claim 1, wherein the at least one instance of digital content is the owner's personal content.

15. The method of claim 1, wherein a digital rights management license associated with the at least one instance of digital content on an owner device includes information about the insurance.

16. The method of claim 15, wherein the information about the insurance comprises at least one of: whether the at least one instance of digital content is insured, what kind of policy insures the at least one instance of digital content, or a specific policy number for a policy insuring the at least one instance of digital content.

17. The method of claim 1, further comprising:
transferring the insurance to an individual to whom the owner of the at least one instance of digital content transfers the at least one instance of digital content.

18. The method of claim 1, wherein the at least one database further stores an association of the owner and insurance purchased by the owner, including the insurance associated with the at least one instance of digital content.

19. A computer readable medium containing an executable program for insuring digital content, where the program performs the steps of:
receiving a request to insure at least one instance of digital content;
associating insurance with the at least one instance of digital content, such that the at least one instance of digital content can be restored to an owner of the at least one instance of digital content in an event that the at least one instance of digital content becomes unusable; and
storing, in at least one database, at least one of: a copy of the at least one instance of digital content, metadata related to the at least one instance of digital content, and data related to the insurance.

20. The computer readable medium of claim 19, wherein the insurance provides for at least one of: replacement of the at least one instance of digital content due to loss, replacement of the at least one instance of digital content due to file corruption, upgrade of a format of the at least one instance of digital content, upgrade of a quality of the at least one instance of digital content, replacement of the at least one instance of digital content due to obsolescence of a digital rights management system protecting the at least one instance of digital content, or replacement of the at least one instance of digital content due to revocation of a device on which the at least one instance of digital content resides.

21. A method for insuring digital content, the method comprising:
receiving a request to insure at least one instance of digital content;
associating insurance with the at least one instance of digital content, such that the at least one instance of digital content can be restored to an owner of the at least one instance of digital content in an event that the at least one instance of digital content becomes unusable,
where a price at which the at least one instance of digital content is insured is discounted if the owner of the at least one instance of digital content insures a minimum number of instances of digital content.

22. A method for insuring digital content, the method comprising:
receiving a request to insure at least one instance of digital content;
associating insurance with the at least one instance of digital content, such that the at least one instance of digital content can be restored to an owner of the at least one instance of digital content in an event that the at least one instance of digital content becomes unusable,
where a price at which the at least one instance of digital content is insured is at least partially dependent on a file quality of the at least one instance of digital content.
